(19) United States
(12) Patent Application Publication
(10) Pub. No.: US 2008/0296164 A1
(43) Pub. Date: Dec. 4, 2008

(54) Reinforcement Element for a Vehicle Hollow Body

(75) Inventors: Ulrich Dajek, Leverkusen (DE); Ralf Zimnol, Overath (DE); Frank Krause, Bergisch Gladbach (DE); Boris Koch, Wermelskirchen (DE); Martin Klocke, Dusseldorf (DE)

Correspondence Address: NORRIS, MCLAUGHLIN & MARCUS, 875 THIRD AVE, 18TH FLOOR, NEW YORK, NY, 10022, US

(73) Assignee: LANXESS DEUTSCHLAND GMBH, Leverkusen (DE)

(21) Appl. No.: 12/131,496

(22) Filed: Jun. 2, 2008

(30) Foreign Application Priority Data
Jun. 2, 2007 (DE) 10 2007 025 930.0
Jun. 9, 2007 (DE) 10 2007 026 762.4

(51) Int. Cl. B32B 3/20; C25D 5/00

(52) U.S. Cl. 205/80; 296/187.02; 428/188

(57) ABSTRACT

The present invention relates to one-piece reinforcement elements consisting of an elongate shell-shaped basic body, the inner space of which has reinforcement ribs which are fixedly connected to the basic body, the reinforcement ribs consisting of plastic injection-molded on and their connection to the basic body taking place at discrete connection points via perforations in the basic body through which the plastic passes and extends over the surfaces of the perforations, and of a rigid structure reinforcement which is appended from the same plastic, by means of the same injection-molded operation, at at least one end of the basic body and which corresponds essentially to the form of the cross section of the hollow profile to be reinforced at this point of a body, an expandable adhesive material being applied over a portion of the surface of the rigid structure reinforcement and of the elongate shell-shaped basic body, the form of the rigid structure reinforcement and of the elongate basic body and also the quantity and distribution of the expandable adhesive being selected such that the adhesive material, during expansion, does not touch the inner surface of the outer panel of the body cavity to be reinforced and touches and adheres to at least part of the other inner walls of the body cavity to be reinforced, to the production of these and to their use.

### BACKGROUND OF THE INVENTION

The present invention relates to a one-piece reinforcement element for a vehicle hollow body, consisting of the combination of a hybrid component with a structure reinforcer, produced from the same thermoplastic, in a non-hybrid type of construction, to a method for its production and to its use in vehicles.

Since raw materials are becoming more expensive, the automobile industry has most recently changed to making vehicle panels thinner, in order to save weight, and additionally to achieve a contribution to reducing fuel consumption. At the same time, however, the safety requirements for vehicle occupants are growing, and therefore vehicles designed with a lighter weight are reinforced, in turn, by means of additional measures on the body.

This has most recently led to the use of what is known as plastic/metal hybrid technology for the production of hollow-chamber lightweight components or hybrid components.

Hybrid components are distinguished by the form fit of a shell-shaped basic body or hollow body and an inserted or appended plastic part injection-molded onto this. The basic body itself may consist of plastic or metal, preferably of metal.

EP-A 0 370 342 discloses a lightweight component of hybrid type of construction consisting of a shell-shaped basic body, the inner space of which has reinforcement ribs which are fixedly connected to the basic body, in that the reinforcement ribs consist of plastic injection-molded on and their connection to the basic body takes place at discrete connection points via perforations in the basic body, through which the plastic passes and extends beyond the surfaces of the perforations, a fixed form fit being achieved. EP-A 0 995 668 supplements this principle by additionally providing the hollow-chamber lightweight component with a cover plate or cover shell consisting of plastic. However, a cover plate consisting of other materials, such as, for example, metal, could also be envisaged.

It was soon recognized that hollow-chamber lightweight components of hybrid type of construction are pre-eminently suitable wherever it is important to have high stability, high energy absorption in the event of a crash and a weight saving, that is to say, for example, in the construction of motor vehicles. EP 0 679 565 B1 discloses the front of a motor vehicle with at least one rigid cross member which extends over the main part of the length of the front part, with at least one supporting part consisting of plastic which is cast on the end region of the rigid cross member. EP 1 032 526 B1 discloses a carrying structure for the front module of a motor vehicle, consisting of a sheet-steel basic body, of a non-reinforced amorphous thermoplastic material, of a glass-fiber-reinforced thermoplastic and of a rib structure consisting, for example, of polyamide. DE 100 53 840 A1 discloses a bumper system or energy absorber element consisting of oppositely arranged metal sheets and connecting ribs composed of thermoplastic or duroplastic. A lightweight component for carrier elements of motor vehicles of hybrid type of construction is known from DE 102 21 709 A1. DE 10 2005 043 698 A1 describes a side sill of a motor vehicle body with a structural part which is manufactured in a hybrid type of construction and which is fixedly connected to the box profile of the sill.

On the other hand, EP 0 897 439 A1 discloses internal reinforcements for hollow structural elements, and DE 42 03 460 C2 describes a method for the production of a carrier-like component with a low-density core. Finally, EP 1 256 512 A2 describes reinforcement elements for a hollow body consisting of a tube encased with foamed-on material.

However, reinforcement elements of this type can be used to only a limited extent. The connection points, for example of the vehicle spar and B-column of a motor vehicle, require individual solutions. What are known as structural inserts have hitherto been employed here and have been glued to the body cavities by means of foams within these. Examples of this technology are disclosed in WO 93/05 103 or EP 1 475 295 A2.

The two solutions in themselves in each case fulfill individual tasks. While hybrid components have hitherto been employed predominantly in the front region of motor vehicles for energy absorption in the event of a crash from the front, a structure reinforcement according to EP 1 475 295 A2 is used within the connections of vehicle spars in crash-relevant regions of the body, for example in the lower part of the A-column, in the lower and the upper part of the B-column and in the cross member above the rear axle.

The object of the present invention was, therefore, to provide a vehicle cavity component which stabilizes a vehicle both in the event of a crash from the front and in the event of a crash from the side and thus protects the vehicle occupants from accident injury by means of energy absorption, but at the same time allows the use of thinner panels in the region of the passenger cell and, moreover, can be employed in a simple and uncomplicated way in the mass manufacture of vehicles.

### SUMMARY OF THE INVENTION

The solution for achieving the object and therefore the subject of the present invention is a one-piece reinforcement element for a vehicle hollow body, which includes
a. an elongate shell-shaped basic body (also hybrid component hereafter), the inner space of which has reinforcement ribs which are fixedly connected to the basic body, the reinforcement ribs consisting of plastic injection-molded on and their connection to the basic body taking place at discrete connection points via perforations in the basic body through which the plastic passes and extends over the surfaces of the perforations, and
b. of a rigid structure reinforcement which is appended from the same plastic, by means of the same injection-molding operation, at at least one end of the basic body and which corresponds essentially to the form of the cross section of the hollow profile to be reinforced at this point of a body, an expandable adhesive material being applied over a portion of the surface of the rigid structure reinforcement and of the elongate shell-shaped basic body, the form of the rigid structure reinforcement and of the elongate basic body and also the quantity and distribution of the expandable adhesive being selected such that the adhesive material, during expansion, does not touch the inner surface of the outer panel, lying in the visible range, of the body cavity to be reinforced, but, instead, touches and adheres to at least part of the other inner walls of the body cavity to be reinforced.

Surprisingly, the reinforcement element according to the invention for a vehicle hollow body proves to be a multi-functional component which can not only be installed quickly and simply during body assembly, but, by virtue of its configuration, also stabilizes corresponding body regions effectively both against a crash from the front and against a crash from the side and, furthermore, functions as acoustic decoupling and as a moisture barrier, while at the same time it allows the vehicle panels to be made thinner in order additionally to save weight and ultimately fuel.

The present invention is illustrated by means of the drawings which show, according to the invention, one-piece reinforcement elements comprising a hybrid component and structure reinforcement for the reinforcement of vehicle bodies.

### BRIEF DESCRIPTION OF THE DRAWINGS

FIG. 1 shows diagrammatically a side-wall frame of a motor vehicle with a reinforcement element according to the invention in the sill region between the connection to the A-column and the connection to the B-column. The one-piece reinforcement element consists, here, of a shell-shaped basic body h and in each case of an appended rigid structure reinforcement.

FIG. 2, section A-A, shows the rigid structure reinforcement d with ribs g. An inner side-wall frame b and an outer side-wall frame a form the hollow body to be reinforced. The inner side-wall frame is welded or adhesively bonded f to the bottom panel c. The inner and the outer side-wall frame are likewise connected to one another f. Adhesive foam e applied in portions and expanded connects the rigid structure reinforcement d to the sill consisting of the inner side-wall frame b and of the outer side-wall frame a.

Section B-B shows the elongate shell-shaped basic body h with reinforcement ribs i. The basic body h is connected in portions via expanded adhesive foam e to the inner side-wall frame and to the outer side-wall frame.

FIG. 3 shows a reinforcement element according to the invention consisting of a ribbed rigid structure reinforcement d and of a ribbed elongate shell-shaped basic body h.

FIG. 4 shows diagrammatically preferred places of use of the cavity reinforcement according to the invention.

### DETAILED DESCRIPTION OF THE INVENTION

The reinforcement element according to the invention may be produced both in one piece in single-shell form and in one piece in two-shell form or overall in two-shell form. In the case of a two-shell version, the elongate shell-shaped basic body consists of two halves, each with its own ribbing. If necessary, the two shells may be welded to one another or bonded with adhesive, for which purpose, if appropriate, the expandable adhesives to be employed may be used.

In a preferred embodiment, both the shell-shaped basic body and the rigid structure reinforcement have small spacer pieces or fastening positions which make it possible to have spacing with respect to the inner walls of the cavity element to be reinforced. Preferably, these are manufactured from the same plastic or from the same metal as the elongate basic body or as the structure reinforcement.

In an alternative or else preferred embodiment, the reinforcement element according to the invention is provided with means which allow fluid drainage. This may be useful if the expandable adhesive is injected only after the introduction of the reinforcement element and after the assembly of the body region to be reinforced. Preferred means are GIT/WIT ducts (GIT=gas internal pressure technology; WIT=water internal pressure technology). In other instances, the ducts may be provided for the outflow of immersion media in the painting process or for the outflow of condensation liquid or rainwater.

In a preferred embodiment, the elongate shell-shaped basic body is directly connected to a rigid structure reinforcement on only one side via the plastic injection-molded on. In this case, the loose appending of a second structure reinforcement at the other end of the elongate shell-shaped basic body makes it possible to compensate manufacturing tolerances. The fixed connection of the loose structure reinforcement to the elongate shell-shaped basic body in this case takes place due to the additional use of adhesive or else due to the expandable adhesive subsequently to be injected.

In the event of a two-shell version of the one-piece reinforcement element, preferably of the elongate shell-shaped basic body, this, too, may preferably be braced mechanically, by the insertion of a soft component, preferably rubber or thick-bed adhesive, against the inside of the body cavity to be reinforced and thus compensate manufacturing tolerances. Soft components preferably to be employed are Therban® or HNBR elastomers (HNBR=hydrogenated nitrile rubber).

The elongate single-shell or two-shell basic body for elongate body cavities is known in principle from EP-A 0 370 342 as what is known as a hybrid component. It may consist both of plastic and of metal. If a metallic basic body is employed, this can be produced by means of deep-drawing methods or by roll-forming.

Untreated galvanized steel sheets and/or steel sheets provided with a primer and, if appropriate, adhesion promoter or untreated anodized aluminum sheets and/or aluminum sheets provided with a primer and, if appropriate, an adhesion promoter is preferably suitable. However, plastic sheets which are deformed by hot-pressing and which consist of thermoplastics with inserts composed of glass-fiber mats or synthetic fiber mats can also be used for the basic body. In particular, part-crystalline plastics, preferably glass-fiber-reinforced polyamide-6, polyamide-6,6, polybutyleneterephthalate, polyphenylenesulphide or polypropylene, are suitable as plastics for injection-molding the reinforcement ribs.

The glass-fiber content preferably amounts to 10 to 75%, particularly preferably to 25 to 65%.

These hybrid components can be produced in that the basic body preformed by deep-drawing or hot-pressing is introduced into an injection-molding die having a correspondingly configured mould cavity, and the reinforcement ribs and, if appropriate, other reinforcements are injection-molded on. According to the invention, this takes place together with the injection-molding of at least one structure reinforcement.

The torsional rigidity and the shearing strength can be increased in the case of V-ribbing by more than 10 times, and they rise even higher in the case of cross-ribbing. Preferably, therefore, the hybrid component has in the inner space a cellular, honeycomb or V- or cross-ribbing. The fracture behavior, brittle per se, of short-glass-fiber-reinforced thermoplastics is positively influenced by the ductile behavior of the metal parts, so that there is no risk of fracture of the structure. If plastic sheets are used for the basic body, similar increases in strength can be achieved.

When a metallic basic body is used, the linear coefficient of thermal expansion is determined essentially by the metal.

According to a preferred embodiment, the anchoring of the plastic on the metal consists of beads which either are directed into the ribs or are directed away from them. These beads may possess a round, elongate, but also irregular cross section. It is particularly advantageous to combine beads with perforations. All these embodiments are distinguished by a particularly good absorption of shearing stresses.

Preferably, the basic body, in particular when it has been manufactured from metal, has at least partially a covering layer which consists of the same plastic as the reinforcement ribs.

It is particularly advantageous if the margins of the perforations have deformations.

As a result, precisely in this critical region, the surface of the basic body is enlarged. Suitable deformations are bead-like indentations of the margins of the perforations. However, the margins may also additionally be incised, and the tongues obtained may be angled or twisted, with the result that particularly firm connections can be achieved. Owing to such deformations, the force flux between the basic body and reinforcement ribs and also other reinforcements injection-molded on is improved. As a rule, the deformations will be directed into the inner space of the basic body in order thereby to achieve a smooth outer surface of the basic body. Alternatively, the deformations may be directed out of the inner space of the basic body in order thereby at the same time to form spacer pieces.

Preferably, the reinforcement ribs possess a widened foot, particularly at the connection points to the basic body. The consequently enlarged contact surface between the basic body and reinforcement ribs thus increases the absorption of shearing forces.

It is also particularly advantageous if the free spaces remaining between the reinforcing ribs and the side walls of the basic body have a trapezoidal cross section instead of a pointed triangular cross section.

As a result, on the one hand, the contact surfaces with the basic body are enlarged and, on the other hand, the force flux between the ribs becomes more favorable. The transition between the individual surfaces of the reinforcement ribs should be rounded in order to rule out notch effects.

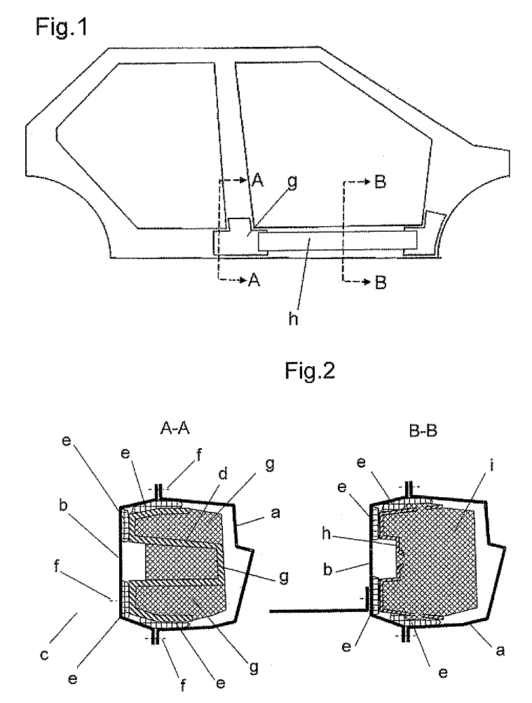

A hybrid component is described by way of example in EP-A 0 370 342. In this, FIG. 1 shows a hybrid component consisting of deep-drawn sheet steel which has been treated with an adhesion promoter. V-shaped reinforcement ribs consisting of polyamide-6 with a glass-fiber content of 30% by weight are provided in its inner space. These reinforcement ribs extend with a web over the entire depth of the inner space and have, towards the bottom of the longitudinal spar, a widened foot. The reinforcement ribs form with the basic body trapezium-like free spaces, there being on the side walls of the longitudinal spar connection webs consisting of the same plastic which run parallel to the side walls and adhere firmly to these. They have approximately the same thickness as the reinforcement ribs. Between the reinforcement ribs and the longitudinal spar, anchoring, illustrated by dashes, in the forth of beads and perforations are provided, through which the plastic extends onto the outside and forms blocks there. The outside is provided with a covering layer of the same plastic. To demonstrate the injection-molding technique, the gate of a molding die, not illustrated, is symbolized by dashes.

In FIG. 2 of EP-A 0 370 342, the basic body consists of sheet' plastic deformed by hot-pressing and composed of polyamide, with an introduced glass-fiber mat, having a weight per unit area of 1950 g/m2 with a sheet thickness of 1 mm and a glass fraction of 78% by weight. Reinforcement ribs consisting of polyamide-6,6 with a glass-fiber content of 35% by weight are arranged in the inner space of this basic body. At the connection points between the basic body and the reinforcement ribs, the basic body has deformations (beads), illustrated by dashes, through which the plastic of the reinforcement ribs extends and forms bolsters on the outside. Moreover, connection flanges and reinforcement lugs consisting of the same plastic are also injection-molded on. According to the invention, the injection-molding of the bolsters or plugs and the forming of these on the opposite side of the perforations may take place in different work steps. Preferably, the operation is concluded by means of at most two work steps.

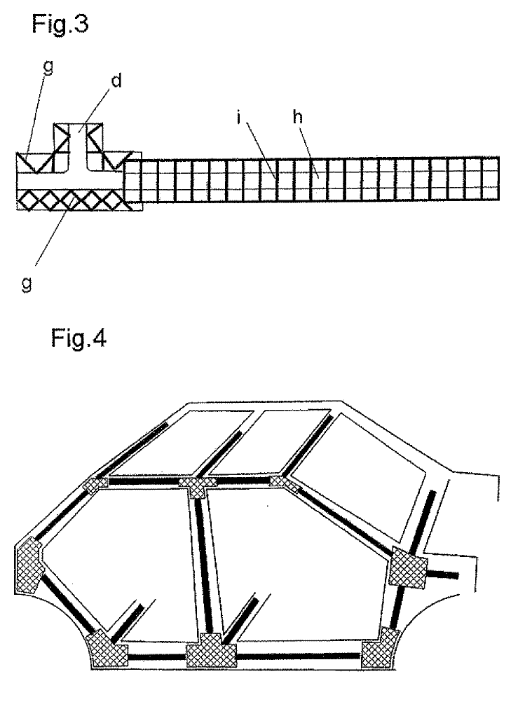

The various anchoring illustrated in FIG. 3 of EP-A 0 370 342 constitute merely a particularly preferred selection from a multiplicity of further possibilities.

The present invention relates to the combination of the hybrid component with at least one rigid structure reinforcement (structure reinforcement insert), by means of which frames or outer panels of bodies can be reinforced, without causing deformation or visual unevenness in the outer surface of the frame/outer panel. Bodies within the meaning of the present invention are bodies of 1-, 2-, 3- or 4-axle vehicles, preferably of 2-axle motor vehicles.

Trends in the design of motor vehicles are towards lighter vehicles in order to reduce fuel consumption. At the same time, safety standards and safety stipulations are becoming more stringent, as can be seen from the provisions of the European Union and the Euro-NCAP impact tests. The use of lighter materials, such as, for example, aluminum, for producing the hollow-profile elements which are employed as auxiliary vehicle frames has led to the need for additional reinforcement. There is also the need for reinforcement behind outer panels at various points in the vehicle, such as, for example, in the vicinity of windows and doors, particularly in cavities between window and door frames and outer panels, such as, for example, in the reinforcement of tailgates and A-columns, where they are connected to the roof of the vehicle.

There are four main types of use where a structure reinforcement is required in vehicles:

impact protection where it is important to reduce a deformation of the vehicle body in order to protect the occupants; energy absorption for improving the component behavior during deformation; reduction of distortion or of body movements in the vehicle structure, particularly in order to improve service life and to reduce stress cracks; and point-mobility problems which make it necessary to reduce resonances by means of stiffening measures. The need for reinforcement is irrespective of the materials which are used for producing the vehicle structure, and the need varies from one material to another according to the type of reinforcement produced. The reinforcement parts may also reduce the noise arising due to the movement of a vehicle, in that they bring about a sound-damping effect because they block air paths in cavities.

A structure reinforcement, connected to the hybrid component, for a hollow profile is a rigid reinforcement element. This has a form which corresponds essentially to the cross section to be reinforced. The expandable adhesive material to be applied according to the invention is in this case applied over a portion of the surface of the rigid reinforcement element, the combination of the form of the rigid structure reinforcement and of the place of application, size and form of the expandable adhesive material being selected such that the material expands, but does not touch that part of the surface which is an outer panel. Visual defects on the painted outer panel also arise due to different heating and cooling rates in the painting process. The situation must therefore be avoided where the expandable adhesive reaches regions of the outer panel which are visible from outside.

Thus, a deformation of the outer body panel during the foaming and/or the cooling of the foamed expandable material is reduced or prevented.

The dimensions of the rigid structure reinforcement and the thickness, place of application and type of the expandable material are critical for achieving the desired body reinforcement and for reducing a deformation or the occurrence of visual unevennesses of the outer body panel. The outer form of the structure reinforcement must correspond essentially to the cross section of the profile of the structure which it is to reinforce, but it must be formed such that the foam does not come to bear against the inner surface of the outer body panel in such a way that it causes a deformation of the panel. The form of the structure reinforcement may vary along its length to the extent to which the dimensions of the profile of the structure change. However, its length is limited, at least on one side, by the hybrid component to be connected fixedly to it in the same injection-molding operation. The size of the reinforcement element, including the expandable adhesive material, must be selected such that a small free space remains between the end of the structure reinforcement and the inner walls of the body structure to be reinforced, so that an electroplating coating fluid can pass through there. Furthermore, the reinforcement element must be formed such that the foam, during expansion, does not touch the inner surface of the visible range of the outer panel, the said inner surface forming part of the walls of the hollow structure. However, the foam must touch other surfaces of the hollow structure and bond with them, so that the rigid structure reinforcement, but also the hybrid component connected to this, are held securely in the vehicle hollow body. Both the structure reinforcement and the hybrid component may have, preferably inside them, a cellular, honeycomb or rib structure, in order to afford reinforcement along a plurality of different axes.

One or more of the walls of the vehicle hollow profile, which is reinforced according to the present invention, may belong completely to the outer panel. Equally, part of one or more walls of the vehicle hollow profile may be formed by an inner structural element, and another part of the walls of the vehicle hollow profile may be formed by an outer panel. In general, only one of the walls which define the vehicle hollow profile is an outer panel, and it may be that only part of one of the walls is an outer panel.

Accordingly, under these circumstances, the one-piece reinforcement element according to the present invention may be formed in that the expandable adhesive foam expands and adheres to that part of the structural element which is not an outer panel, and does not touch that part of the element and does not adhere to that part of the element which fortes the outer panel. In this case, the outer panel may be reinforced by virtue of the proximity of the foam and/or of the core of the structure reinforcement to the outer panel. This may be achieved by means of the corresponding distribution of the expandable adhesive material over the surface of the core and the application of the corresponding quantity of foamable material. The optimal distribution and quantity of expandable material depend on the size and form of the hollow profile both of the structure reinforcement and of the hybrid component connected to this.

The one-piece reinforcement element according to the invention consisting of the hybrid component and structure reinforcement must preferably be arranged in the hollow profile to be reinforced, in a way which allows a satisfactory execution of an electroplating coating process, preferably cathodic immersion painting (KTL), without an undesirable movement of the unit. Various fastening means may preferably be used for this purpose. Means, such as, for example, holding clips, may be formed into the core, which are suspendable in holes in the walls of the hollow profile which are not a wall or walls forming the outer panel.

Equally, fastening means, such as, for example, holding clips, which can be inserted into holes in the core of the reinforcement element, may be formed in the walls of the hollow profile which do not belong to the outer panel. Alternatively or additionally, the reinforcement element consisting of the hybrid component and structure reinforcement may be provided with small noses which enable it to maintain spacing with respect to the inner walls of the hollow structure. Thus, fastening devices are not required, and the contact surface between the one-piece reinforcement element and the inner walls of the vehicle frame is minimized. However, the noses should not touch that wall of the hollow structure which forms the inner surface of the outer panel.

The free space between the end of the one-piece reinforcement element and the inner walls of the hollow profile must preferably be of sufficient width to ensure that the liquid used in an electroplating coating bath can flow in sufficient quantity between the reinforcement element and the inner walls of the profiles of the vehicle, so that an effective corrosion protection coating can be deposited. On the other hand, the free space should not be too wide, because the rigidity of the structure may thereby be lost due to the liquid of the electroplating coating bath when the expandable adhesive is foamed in order to connect the reinforcement element to the walls of the hollow profile, with the exception of the outer panel. Preferably, a free space of at most 1 centimeter, particularly preferably of 3 to 10 millimeters, is selected. The free space around the overall structure makes it possible to have a more uniform foam structure.

Like the hybrid part, the rigid structure reinforcement, too, may consist of any suitable material. Like the hybrid part, it may preferably consist of metal or plastic. The material is selected according to the preferred production method. This, in turn, is determined by economic factors and the complexity of the profile to be reinforced. The one-piece reinforcement element according to the invention consisting of a hybrid component with at least one structure reinforcement may be produced, in the case of simple profiles, by means of extrusion, while injection-molding may be required for more complex structures. Metal elements may be produced by stamping and/or forming. Where extrusion is employed, the elements may consist of metal or thermoplastic material. Where injection-molding is employed, thermoplastic materials are preferred. Polyamides, in particular the glass-filled polyamides already described above, are suitable materials because of their high strength/weight ratio. Alternatively, the injection-molding or die-casting of metal alloys may be employed. It is preferred that the overall one-piece reinforcement element be provided with means which allow fluids to flow out. For example, holes may be present, in order to allow the outflow of water which settles in the structure in the course of time due to condensation.

The preferred form and structure of the one-piece reinforcement element depend on where it is to be arranged in the vehicle structure and what function it is to fulfill. The present invention is particularly suitable for the reinforcement of regions around the sill of bodies of vehicles, such as at the connection points of sills to the A- and/or B-column or of the A- or B-column to a roof bow, the hybrid part being accommodated in the elongate body part. It is likewise suitable for the reinforcement of front windscreen frames where they adjoin the roof of the vehicle which may be the outer panel. While, according to the invention, the hybrid component is preferably fixedly connected on one side to a structure reinforcement by means of the production process, a further structure reinforcement may be loosely attached on the other side of the hybrid component and is fixedly connected only by means of the expandable foam adhesive to the hybrid component and to the inside of the body cavity to be reinforced. In individual instances, however, a hybrid component with a structure reinforcement injection-molded on both sides in the same production process may, of course, also be employed. This depends on whether manufacturing tolerances have to be compensated. Conversely, however, a structure reinforcement may also be provided on both sides or even in further spatial directions with more than one hybrid part. According to the place of use in the body to be reinforced, the possibilities of the combination of a structure reinforcement with two, three or even four hybrid parts are afforded.

The expandable adhesive material fulfils two main functions: it expands throughout the space between the one-piece reinforcement element and the inside of the hollow profile, without touching the inner surface of the outer panel, and, moreover, the material bonds with some or all inner walls of the hollow structure which do not form an outer panel. Correspondingly, according to the invention, “expandable adhesive material” means that the material can be activated in order both to expand (as a rule, to foam) and to function as an adhesive. Activation enables the expandable material to expand and to fill a gap between the one-piece reinforcement element and that hollow structure which is to be reinforced, and to bond with selected inner surfaces of the hollow structure. Accordingly, the expandable plastic must expand at the desired temperature and must have a sufficient adhesive capacity to connect the one-piece reinforcement element fixedly inside the vehicle structure. After foaming, it must be sufficiently firm to ensure that no weak points infiltrate into the overall reinforcement process. The distribution of the foamable material over the reinforcement core takes place such that it does not cause any defamation of the outer panel during and after foaming. According to this invention, this is achieved by minimizing the contact surface between the foam and the inner surface of the outer panel which forms the visible range, the contact surface preferably amounting to zero. By careful control, it is possible to reinforce an outer panel, while a small gap remains between the inner surface of the outer panel and the foam. This ensures that the thin sheet of the outer panel is not deformed due to the contraction of the foam during the cooling and shrinkage of the latter.

Before activation, the expandable adhesive material is preferably dry and not tacky, because this simplifies dispatch and handling and prevents soiling. The examples of preferred foamable materials include foamable epoxy resins. Examples of such materials are the products L5206, L5207, L5208 and L5209 of the company L & L Products from Romeo, Mich., USA, or the Betacore products 5204, 5206, 5205 and 5208 of the company L&L Products Europa. The recipes for these adhesives are described in US 2004 022 1953, and the method for processing them is disclosed in US 2004 014 3969. The product must be selected according to the required expansion rate and foam densities. It is preferred, furthermore, that it expands at the temperatures which occur in the electroplating coating furnace, as a rule 100° C. to 200° C.

The expandable adhesive material is applied to at least one portion of the surface of the rigid reinforcement element consisting of the hybrid part and structure reinforcement which is located next to an inner surface of the vehicle frame profile to be reinforced, while the quantity of foam next to the outer panel is controlled. It is preferred that the foamable material be applied over at least part of all the surfaces of the reinforcement element which are located next to the walls of the vehicle profile, and that the quantity and place of application of the foamable material, which is applied over the surface of the reinforcement material next to the inner surface of the outer panel, be controlled such as to prevent the foam from causing a deformation of the outer panel. The optimal distribution depends on the form of the profile to be reinforced, but the foam is preferably arranged such that it bonds two non-parallel surfaces to one another in order to impart strength in at least two dimensions. The expandable material may be applied to the rigid reinforcement element by the gluing of a strip of the material to the element, by extrusion coating or by injection-molding. Where the reinforcement element is produced by injection-molding, the expandable material may be applied by over-molding or by two-stage injection-molding. However, the material must be applied under conditions under which no foaming takes place.

The thickness of the expandable adhesive material and the degree of expansion must be controlled such that the foam, during expansion, fills the space between the rigid reinforcement element and the hollow profile, but such that the foam does not touch the inner surface of the outer body panel to an extent such that the cooling of the expanded foam deforms the outer body panel. This may be achieved in that no expandable material is applied to that surface of the one-piece reinforcement element which is located next to the inner surface of the outer panel, or in that the quantity and thickness of the expandable material on the surface of the one-piece reinforcement element next to the outer panel are controlled such that, during expansion, it is located in direct proximity to the inner surface of the outer panel, but touches at most 50% of the inner surface of the outer panel and preferably does not touch the inner surface of the outer panel at all.

The hollow profile having the one-piece reinforcement element located in place can then be subjected to the electroplating coating process in which it is conducted through a bath of coating material and a corrosion protection coating is deposited by means of electrolysis on the structure. The vehicle structure is then dried in a furnace in order to complete the coating, and the expandable adhesive is preferably selected such that it is activated by the drying conditions which prevail in the furnace, in order to bake the coating applied by means of the electroplating coating process. Thus, the expandable material expands under the drying conditions, in order to generate a foam which fills the space between the reinforcement element and the inner walls and makes a fixed connection between the one-piece reinforcement element and the inner wall. As a rule, the coated structure is dried at 100-200° C., preferably at 160-190° C., in particular at 165-185° C., for a period of time of up to 25 30 minutes, preferably 10-25 minutes, and the adhesive must correspondingly expand under these conditions. However, the industry endeavors to use lower drying temperatures and shorter drying times, and this may influence the selection of expandable adhesive materials.

If other components, for example screws, are to be led through the one-piece reinforcement element during subsequent assembly, then care must be taken to ensure that holes formed in the reinforcement element for leading through the screws are not blocked by the foam when the latter expands.

The techniques of the present invention may be employed for reinforcing any construction based on a hollow frame structure in which at least part of one or more walls is an outer panel in combination with an elongate cavity. The techniques may be employed, for example, in the construction industry or in the building of ships, aircraft and rail vehicles. They are particularly suitable, however, for the reinforcement of 1-, 2-, 3- or 4-axle, preferably 2-axle vehicles, preferably motor vehicles, including passenger cars, heavy goods vehicles, mobile homes and the like. The techniques are particularly suitable for the current trend towards the use of lighter and sometimes weaker materials in the production of auxiliary motor vehicle frames, where there is a greater need for reinforcement in order to compensate the reduction in strength of the basic material and nevertheless fulfill safety stipulations. This applies most particularly to the use of aluminum for the construction of automobiles.

The present invention also relates, however, to a method for the reinforcement of a hollow element, comprising the provision of a rigid reinforcement element consisting of a hybrid part and structure reinforcement within the hollow element, with a cellular, honeycomb or ribbed inner structure and with a form which is essentially conform to the cross section of the portion of the hollow element, and with an expandable adhesive material which is applied over at least a portion of the surface of the rigid reinforcement element which is sufficient for the reinforcement element to adhere to at least two non-parallel inner surfaces of the hollow element, characterized in that, before activation, the expandable adhesive material being dry and stick-free upon contact, and the reinforcement being of a size such that there is an interspace between the surface of the expandable adhesive material and the inner walls of the hollow element, the rigid reinforcement element is provided on its outer surface with small spacer pieces which enable it to have a spacing with respect to the inner walls of the hollow element, the hollow element, which contains the rigid reinforcement element, being subjected to the electroplating coating anti-corrosion process in which the expandable adhesive material expands at the temperatures at which the electroplating coating baking furnace is operated.

The invention also relates, however, to the use of one-piece reinforcement elements which includes
a. an elongate shell-shaped basic body, the inner space of which has reinforcement ribs which are fixedly connected to the basic body, the reinforcement ribs consisting of plastic injection-molded on and their connection to the basic body taking place at discrete connection points via perforations in the basic body through which the plastic passes and extends over the surfaces of the perforations, and
b. of a rigid structure reinforcement which is appended from the same plastic, by means of the same injection-molding operation, at at least one end of the basic body and which corresponds essentially to the form of the cross section of the hollow profile to be reinforced at this point of a body, an expandable adhesive material being applied over a portion of the surface of the rigid reinforcement element and of the elongate shell-shaped basic body, the form of the rigid reinforcement element of the elongate basic body and also the quantity and distribution of the expandable adhesive being selected such that the adhesive material, during expansion, does not touch the inner surface of the outer panel, lying in the visible range, of the body cavity to be reinforced, but, instead, touches and adheres to at least part of the other inner walls of the body cavity to be reinforced, for the purpose of the reinforcement a hollow element, preferably of a hollow element which is part of a vehicle.

It will be understood that the specification and examples are illustrative but not limitative of the present invention and that other embodiments within the spirit and scope of the invention will suggest themselves to those skilled in the art.

What is claimed is:

1. A one-piece reinforcement element comprising
a. an elongate shell-shaped basic body having an inner space with reinforcement ribs which are fixedly connected to the basic body, the reinforcement ribs include plastic injection-moldings on the basic body formed at discrete connection points via perforations in the basic body through which plastic from the injection moldings passes and extends over the surface of the perforations, and
b. a rigid structure reinforcement which extends from the plastic from the injection-molding operation, at at least one end of the basic body and which corresponds essentially to the form of a cross section of a hollow profile to be reinforced at this point of a body, an expandable adhesive material being applied over a portion of a surface of the rigid structure reinforcement and of the elongate shell-shaped basic body, the form of the rigid structure reinforcement and of the elongate basic body and also the quantity and distribution of the expandable adhesive being selected such that the adhesive material, during expansion, does not touch the inner surface of the outer panel, lying in the visible range, of the body cavity to be reinforced, but, instead, touches and adheres to at least part of the other inner walls of the body cavity to be reinforced.

2. The one-piece reinforcement element according to claim 1, wherein the outer form of the structure reinforcement corresponds essentially to the cross section of the profile of the structure which is to reinforce.

3. The one-piece reinforcement element according to claim 1, wherein the structure reinforcement and the hybrid part having a size, including the expandable adhesive material, which is selected such that a small free space remains between the outer surface of the two part-structures and the inner walls of the cavity to be reinforced, so that an electroplating coating fluid can pass through there.

4. The one-piece reinforcement element according to claim 1, wherein either the hybrid part or the structure reinforcement or both together are produced from metal or plastic.

5. The one-piece reinforcement element according to claim 3, further comprises a fluid drainage.

6. The one-piece reinforcement element according to claim 1, wherein the adhesive material is expandable at a temperatures present in a baking furnace suitable for electroplating coating.

7. The one-piece reinforcement element according to claim 6, wherein the temperature is about 100° C. to 200° C.

8. The one-piece reinforcement element according to claim 7, wherein the expandable adhesive material is applied to at least partially to a top side, an underside and sides of the reinforcement element.

9. The one-piece reinforcement according to claim 4, wherein plastic produced by injection-molding is used.

10. A one-piece reinforcement element according to claim 1, comprising a two-shell construction.

11. A one-piece reinforcement element according to claim 10, comprising a soft component inserted between the two shells.

12. A hollow element with reinforcement element according to claim 1, the expandable adhesive material being expanded so that the reinforcement element adheres to the inner surface of the hollow element.

13. The hollow element according to claim 12, being part of the 1-, 2-, 3- or 4-axle vehicle frame or vehicle outer panel.

14. The hollow element according to claim 13, comprising an A-column, or a B-column or A C-column of a vehicle.

15. The hollow element according to claim 13, being part of a 2-axle vehicle.

16. A method for reinforcing a hollow element, comprising
providing a rigid reinforcement element including a hybrid part and structure reinforcement within the hollow element, having a cellular, honeycomb or ribbed inner structure and having a form which essentially conforms to a cross section of a portion of the hollow element, and with an expandable adhesive material which is applied over at least a portion of the surface of the rigid reinforcement element which is sufficient for the reinforcement element to adhere to at least two non-parallel inner surfaces of the hollow element,
providing before activation, the expandable adhesive material in a dry and stick-free fashion, and
sizing the reinforcement such that there is an interspace between the surface of the expandable adhesive material and the inner walls of the hollow element,
providing the rigid reinforcement element on its outer surface with small spacer pieces which enable it to have a spacing with respect to the inner walls of the hollow element,
subjecting the hollow element, which contains the rigid reinforcement element to the electroplating coating anti-corrosion process in which the expandable adhesive material expands at the temperatures at which the electroplating coating baking furnace is operated.

17. A method according to claim 16, wherein the expandable material expands at 100° C. to 200° C.
